(19) United States
(12) Patent Application Publication
(10) Pub. No.: US 2019/0193493 A1
(43) Pub. Date: Jun. 27, 2019

(54) LAWN MOWER CART

(71) Applicant: Chris Edward Gaalema, Avon, IN (US)

(72) Inventor: Chris Edward Gaalema, Avon, IN (US)

(21) Appl. No.: 16/230,171

(22) Filed: Dec. 21, 2018

Related U.S. Application Data
(60) Provisional application No. 62/608,781, filed on Dec. 21, 2017.

(51) Int. Cl. B60D 1/167; A01D 42/00; B60D 1/14

(52) U.S. Cl. CPC B60D 1/167; A01D 34/64; B60D 1/143; A01D 42/00

(57) ABSTRACT

A mower and cart are attached with a hitch that allows movement of the cart relative to the mower about two axes and constrains movement of the cart relative to the mower about another axis.

### RELATED APPLICATIONS

The present application claims the benefit of U.S. Provisional Patent Application No. 62/608,781 to Chris Gaalema entitled “Lawn Mower Cart” and filed on December 2017, which is hereby incorporated by its reference in entirety.

### BACKGROUND AND SUMMARY OF THE DISCLOSURE

Zero-turn lawn mowers have become more popular among private and commercial consumers due to their increased efficiency and speed in comparison to traditional lawn mowers. Zero-turn lawn mowers typically utilize independently controlled rear wheels rather than rear wheels that are controlled together. Each rear drive wheel of a zero-turn lawn mower is typically controlled independently with a dedicated steering handle. Independently operating the steering handles varies the magnitude and direction of torque applied to each drive wheel, which changes the speed and direction of the zero-turn lawn mower. This steering system reduces the turning radius of the zero-turn lawn mower to near zero, allowing the zero-turn lawn mower to turn substantially within its own footprint. This increases maneuverability and speed, which in turn reduces the time needed to mow a lawn.

Zero-turn lawn mowers have become more popular among private and commercial consumers due to their increased efficiency and speed in comparison to traditional lawn mowers. Zero-turn lawn mowers typically utilize independently controlled rear wheels rather than rear wheels that are controlled together. Each rear drive wheel of a zero-turn lawn mower is typically controlled independently with a dedicated steering handle. Independently operating the steering handles varies the magnitude and direction of torque applied to each drive wheel, which changes the speed and direction of the zero-turn lawn mower. This steering system reduces the turning radius of the zero-turn lawn mower to near zero, allowing the zero-turn lawn mower to turn substantially within its own footprint. This increases maneuverability and speed, which in turn reduces the time needed to mow a lawn.

One drawback to zero-turn lawn mowers is the difficulty of pulling a trailer and backing up with a trailer behind the lawn mower. Lawn mowers are sometimes used to transport loads such as lawn debris and building materials by towing a trailer behind the lawn mower. The larger turning radius of a traditional lawn mower more suitably matches most trailers, which are less capable of being reversed or backed up. However, pulling and backing up a traditional trailer with a zero-turn lawn mower can more readily cause the trailer to jackknife. This increases the difficulty of pulling and backing up a trailer behind a zero-turn lawn mower.

### SUMMARY OF THE DISCLOSURE

The present disclosure relates to a cart and hitch system designed, in a preferred embodiment, to be attached to the front of a zero-turn lawn mower. In some embodiments, the cart and hitch system is designed to be attached to a drive vehicle, such as a zero-turn mower, with a hitch having two degrees of rotational freedom between the drive vehicle and the cart to facilitate turning of the drive vehicle and reduce jackknifing of the cart. More specifically, in some embodiments, the cart is allowed to rotate about the two horizontal axes of rotation relative to the drive vehicle, but is fixed along the vertical axis of rotation relative to the drive vehicle. In some embodiments, the cart has two caster wheels to facilitate the rotation of the cart about a vertical axis of rotation of the drive vehicle.

According to one aspect of the present disclosure, a mower and cart system is provided that comprises a mower having a mower frame, a seat supported by the mower frame, a plurality of wheels supporting the mower frame, and at least one blade supported by the mower frame and configured to cut grass. The plurality of wheels includes first and second wheels configured to power propulsion of the mower and cooperating to define a wheel axis of rotation. The system further includes a cart having a cart frame and at least one wheel supporting the cart frame and a hitch coupling the cart to the mower and defining first, second, and third axes of rotation between the mower and the cart. The first axis of rotation is parallel to the wheel axis. The second axis is vertical and a third axis is perpendicular to the first and second axes of rotation. Rotation about at least one of the first and third axes of rotation is unconstrained to allow rotational movement between the mower and the cart. Rotation about the second axis of rotation is constrained to substantially block rotational movement between the mower and the cart about the second axis of rotation.

According to another aspect of the present disclosure, a mower and cart system is provided that comprising a mower having a mower frame, a seat supported by the mower frame, a plurality of wheels supporting the mower frame, and at least one blade supported by the mower frame and configured to cut grass. The plurality of wheels including first and second wheels configured to power propulsion. The system further includes a cart having a cart frame and at least one wheel supporting the cart frame, and a hitch coupling the cart to the mower. The seat faces in a forward direction and the cart is positioned forward of the seat.

According to another aspect of the present disclosure, a method of moving material using a mower and cart is provided. The method includes the steps of providing a mower and a cart coupled a front of the mower, loading material into the cart, propelling the mower and cart, constraining movement of the cart relative to the mower about a vertical axis of rotation, rotating the cart relative to the mower about a first horizontal axis of rotation, and rotating the cart relative to the mower about a second horizontal axis of rotation that is perpendicular to the first horizontal axis of rotation.

Additional features of the present disclosure will become apparent to those skilled in the art upon consideration of the following detailed description of the illustrative embodiment exemplifying the best mode of carrying out the disclosure as presently perceived.

### BRIEF DESCRIPTION OF THE DRAWINGS

The aforementioned aspects and many of the intended features of this disclosure will grow to be appreciated at a greater level once references to the following accompanying illustrations are expounded upon.

FIG. 1 is a perspective view of a zero-turn mower, hitch, and a cart system, illustrating a plurality of degrees of freedom between the cart system and the zero-turn mower provided by the hitch.

FIG. 2a is a top view of the zero-turn mower and the cart system of FIG. 1 attached to the zero-turn mower, illustrating the degrees of freedom between the zero-turn mower and the cart system.

FIG. 2b is a side view of the zero-turn mower and the cart system of FIG. 1 attached to the zero-turn mower, also illustrating the degrees of freedom between the zero-turn mower and the cart system.

FIG. 2c is a front view the zero-turn mower and the cart system of FIG. 1 attached to the zero-turn mower, also illustrating the degrees of freedom between the zero-turn mower and the cart system.

FIG. 3 is a top view of the zero-turn mower and a portion of the cart system of FIG. 1 showing rotation about a vertical axis.

FIG. 4 is a top view of a hitch of FIG. 1 illustrating components of the hitch and connection points among the systems.

FIG. 5 is a side view of the zero-turn mower, the hitch, and the cart system of FIG. 1, illustrating components of the hitch and connection points among the systems.

FIG. 6 is an front view of the zero-turn mower, the hitch including a frame, and the cart system of FIG. 1

FIG. 7 is a front elevation view of the hitch of FIG. 1 including a mount crossbar, a plurality of mounting arbors, a plurality of mounting arbor clamps, a plurality of mounting rails and a plurality of mounting height clamps.

FIG. 8 is a top plan view of the hitch of FIG. 1 including the mount crossbar, a plurality of end clamps, mounting arbor clamps, and mounting rails.

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

### DETAILED DESCRIPTION OF THE DRAWINGS

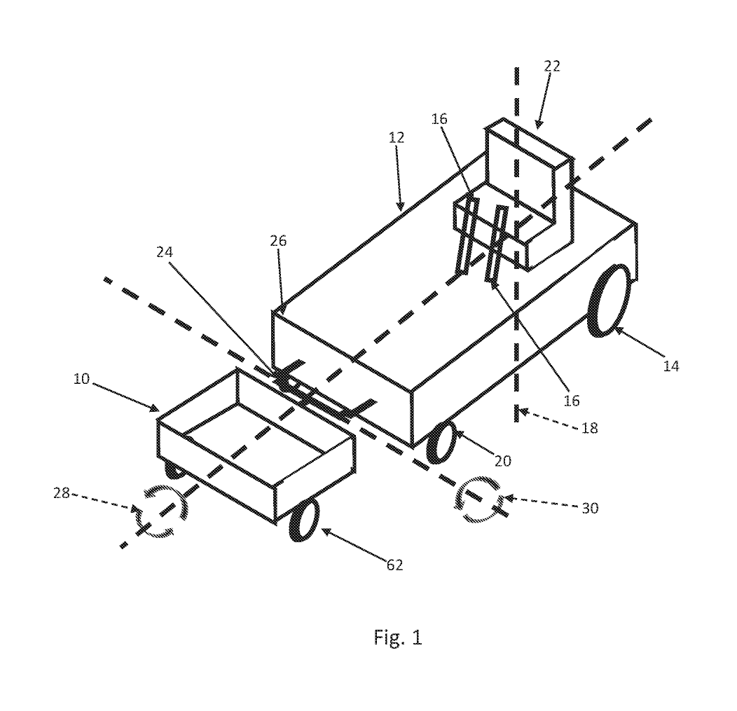

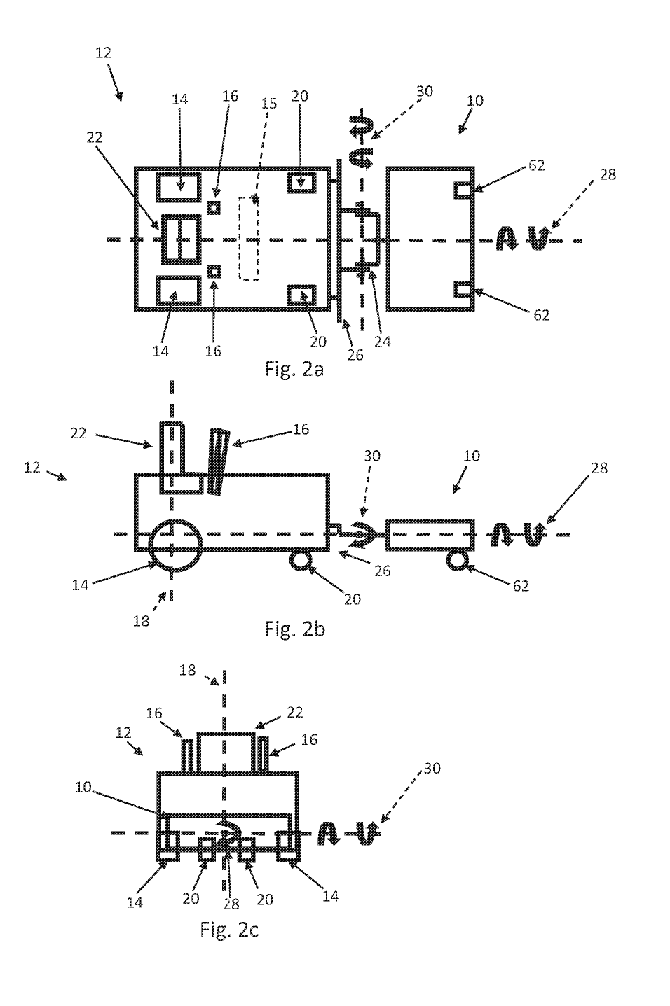

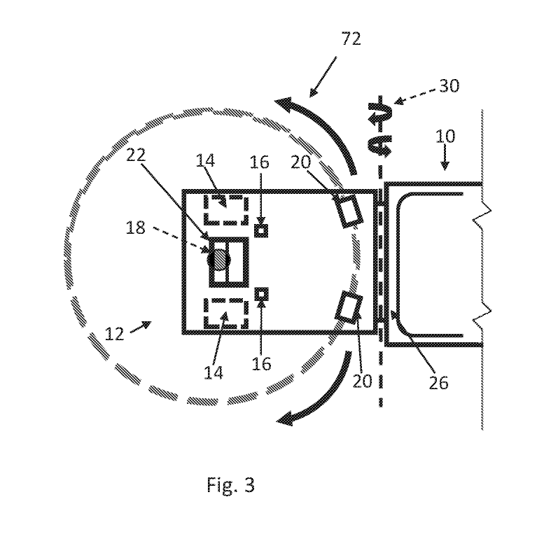

Zero-turn mowers 12 are known in the art. As shown in FIGS. 1-3, mower 12 includes a plurality of front wheels 20 along with a plurality of independently controlled rear wheels 14. Mower 12 also includes a mower seat 22 and a plurality of levers 16 that allow mower 12 to spin about a mower or vertical axis of rotation 18 between rear wheels 14. Particular to the design, each independently controlled rear wheel 14 of mower 12 is independently controlled by an operator using dual levers 16 simultaneously, one for each rear wheel 14 respectively, to move mower 12 in the horizontal plane. By operating rear wheels 14 independently, vertical axis of rotation 18 of mower 12 can move depending on how much and in which direction handles 16 are operated. If handles 16 are operated in opposite directions so rear wheels turn at the same speed in opposite directions, vertical axis of rotation 18 will be positioned substantially between rear wheels 14 as shown in FIG. 1. As shown in FIG. 3, front wheels 20 of mower 12 are typically caster type wheels, allowing travel of wheels 20 about vertical axis 18 as mower 12 spins around vertical axis 18 between rear wheels 14 along path 72. As shown in FIG. 3, front wheels 20 can travel perpendicular to vertical axis 18 as mower 12 turns and may also travel in other directions. Thus, wheels 20 can rotate relative to the ground and the mower frame/body about a horizontal axis and rotate relative to the ground and the mower frame/body about a vertical axis of rotation giving wheels two unconstrained degrees of freedom.

An operator controls zero-turn mower 12 from seat 22 located between levers 16. As mentioned above, vertical axis 18 may pass through seat 22 when rear wheels 14 drive mower 12 to turn in opposite directions at the same speed. However, the location of vertical axis 18 of mower 12 is dependent on the direction and independent speed of rotation of rear wheels 14. For example, to maneuver around an object, such as a tree, a user may use levers 16 to slow down one of rear wheels 14, typically rear wheel 14 closest to the object, relative to other rear wheel 14 while both rear wheels 14 move in the same direction. This results in vertical axis 18 being outside of the footprint of mower 12, often near the center of the object. As such, the turning radius and direction of turning (i.e. clockwise or counterclockwise) of mower 12 may be controlled by the direction and/or speed of rotation of rear wheels 14 as controlled by the user by levers 16.

Referring again to FIGS. 1-3, a cart 10 and a hitch 24 are shown attached to a front 26 of mower 12. According to the present disclosure, hitch 24 allows two degrees of rotational freedom for cart 10 relative to mower 12. More specifically, cart 10 is able to rotate about a longitudinal axis 28 and a lateral axes 30, but remains rotationally fixed with regards to rotation about a vertical axis 18. Lateral axes 30 is parallel to an axis of rotation of wheels 14. This embodiment facilitates movement of cart 10 with mower 12 even through tight turns and over uneven terrain.

Because of the fixed relationship of mower 12 and cart 10 about vertical axis 18, cart 10 rotates with mower 12 about vertical axis 18 when mower 12 turns about vertical axis 18. This fixed relationship reduces, if not eliminates, cart 10 jackknifing with mower 12 during turning of mower 12 about vertical axis 18.

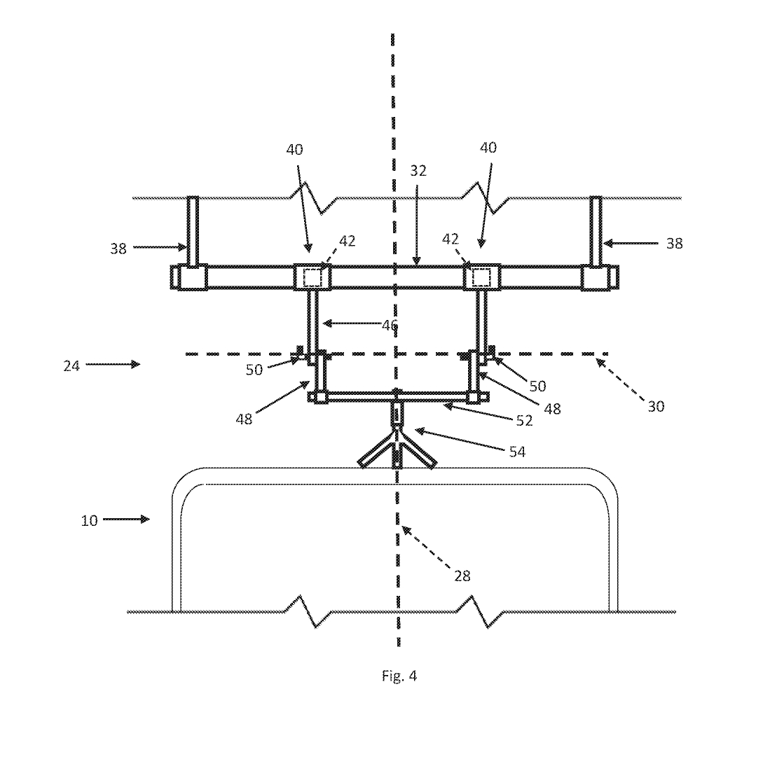

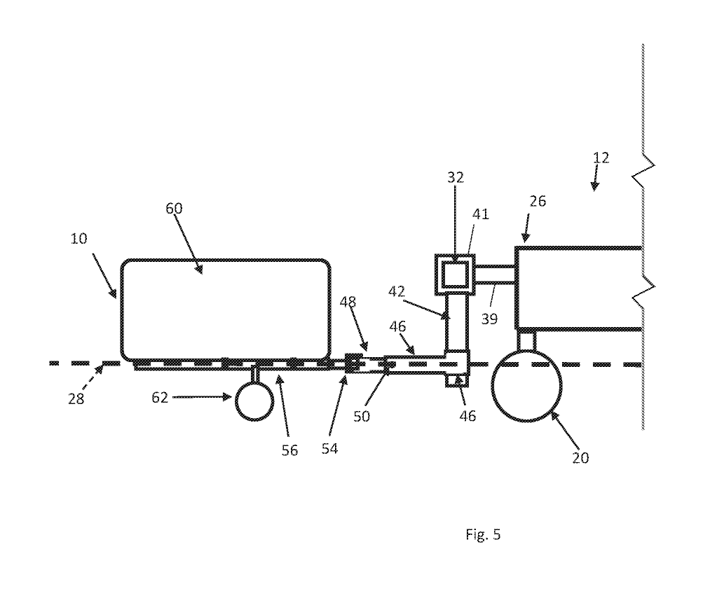

As shown in FIGS. 4 and 5, hitch 24 is attached to cart 10 by a plurality of pivot mount extensions 48. Mounting rails 46 couple to pivot mount extensions 48 with a plurality of hitch pins 50 that go into a plurality of fastener reception holes 59 that define lateral axis 30. Pivot mount extensions 48 allow for independent movement of mower 12 and cart 10 about lateral axis 30, as discussed above. To remove cart 10 from mower 12, hitch pins 50 may be removed from fastener reception holes 59.

Hitch 24 further includes a crossbar 52 extending between pivot mount extensions 48 and sleeve and pin joint 54 that allows cart 10 to rotate relative to mower 12 about longitudinal axis 28. In addition to allowing either side of cart 10 to rotate up and down about longitudinal axis 28, sleeve and pin joint 54 allows a user to lift one side of cart 10 to dump material stored in cart 10 from the opposite side of cart 10.

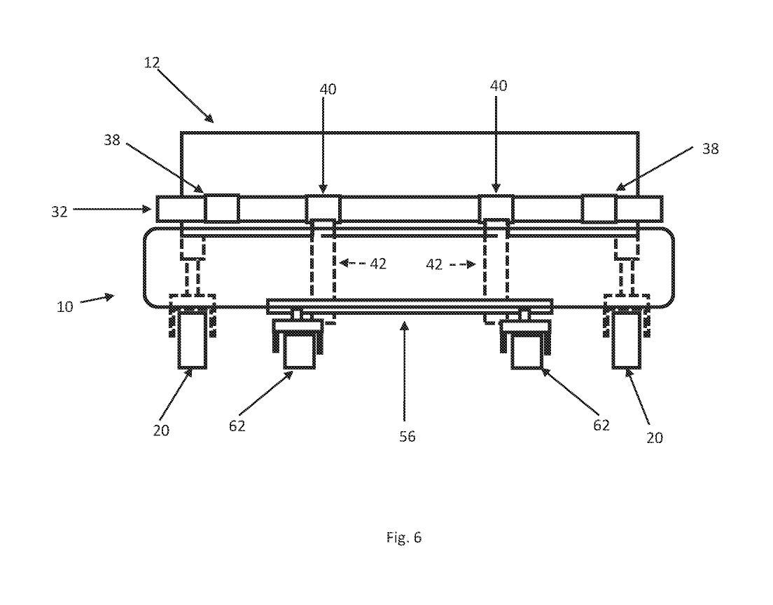

As shown in FIGS. 5-6, cart 10 includes a bin 60 being supported by a frame 56. Further included in one embodiment, frame 56 and a plurality of caster 62 are coupled to cart 10. Frame 56 is supported by a plurality of caster wheels 62 and is attached to a sleeve and pin joint 54 to allow movement about longitudinal axis 28 of mower 12.

As indicated in FIGS. 4-6, cart 10 includes frame 56 coupled to sleeve and pin joint 54, bin 60 supported by frame 56, and caster wheels 62 that support frame 56 and can rotate freely about vertical axis 18 with frame 56. In one embodiment, cart 10 is shown with bin 60, but other embodiments include attachments to cart 10 such as a plug aerator, bagger, mulcher, roller, or similar attachments may be attached to mower 12.

Although cart 10 and mower 12 are fixed or constrained against relative rotation about vertical axis 18, cart 10 may move relative to mower 12 when mower 12 moves over uneven terrain. For example, if mower 12 pushes cart 10 up an incline (ex. a hill), cart 10 can rotate about lateral axis 30 independent of the angle by which mower 12 is traversing. Similarly, if mower 12 pushes cart 10 down an incline (ex. into a valley, over a crest of a hill, etc.), cart 10 can rotate in an opposite direction about lateral axis 30. Additionally, if mower 12 pushes one side of cart 10 over an object (or along the side of a hill, etc.), cart 10 can rotate about longitudinal axis 28 so that one side of cart 10 rotates up relative to mower 12 and the opposite side of cart 10 rotates down relative to mower 12, all things being equal. Little, if any, linear movement is provided between cart 10 and mower 12. Thus, mower 12 and cart 10 have two degrees of rotational freedom (about axes 28, 30) between that are unconstrained and the other four potential degrees (about the vertical axis and linear movement along the three axes) of freedom are constrained or fixed.

Referring to FIGS. 4-8, hitch 24 facilitates both the fixed and unfixed rotational degrees of freedom of cart 10 and mower 12. Hitch 24 includes a hitch crossbar 32 and a plurality of end clamps 38 attached to hitch crossbar 32. End clamps 38 further include a mounting clamp 34, an extension arm 39, and a crossbar clamp 41. Mounting clamps 34 facilitate the coupling of end clamps 38 to front 26 of mower 12 (or any other vehicle) using a fastener 58. Hitch 24 further includes a plurality of mounting arbor clamps 40 that attach a plurality of mounting arbors 42 to hitch crossbar 32. Hitch 24 also includes a plurality of mount height clamps 44 that are attached to a plurality of mounting rails 46 and secured by a plurality of fasteners 58.

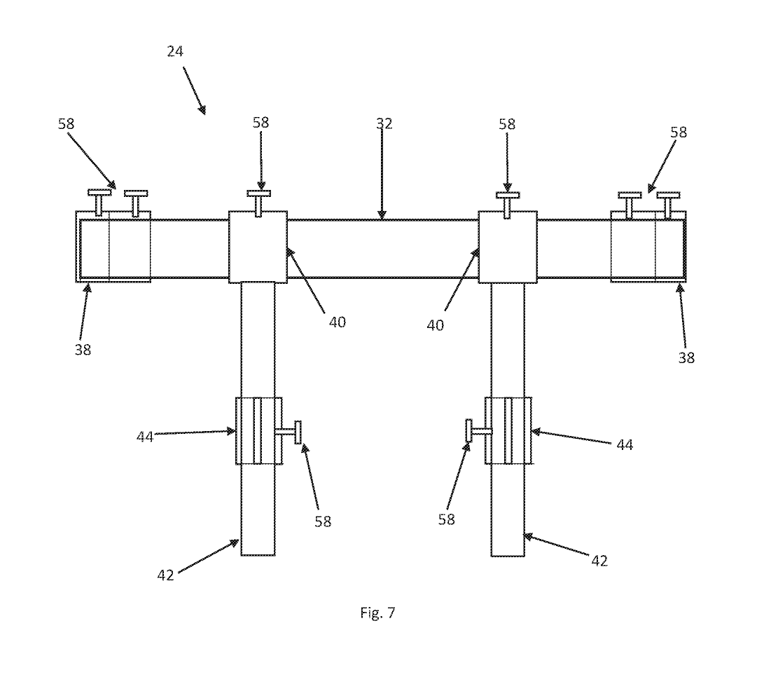

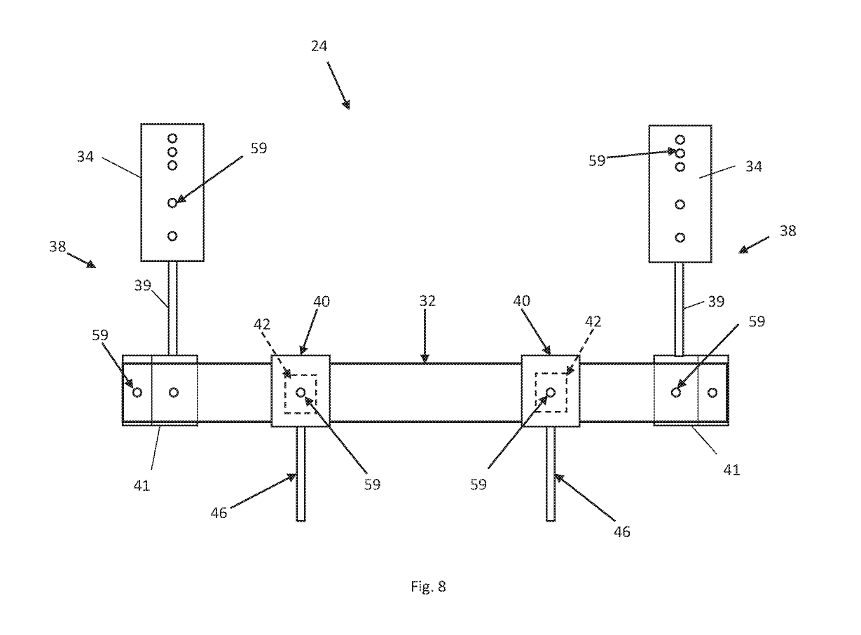

As further shown in FIGS. 7 and 8, mounting arbor clamps 40 attach mounting arbors 42 to crossbar hitch 32 and allow mounting arbors 42 to be adjusted horizontally along hitch crossbar 32. Mounting arbors 42 extend vertically downwards from hitch crossbar 32. Mount height clamps 44 attach mounting rails 46 to mounting arbors 42. Mounting rails 46 may be adjusted vertically along mounting arbors 42. Mount height clamps 44 secure mounting rails 46 in a number of configurations. After adjusting to a desired elevation and alignment, mounting arbors 42 and mount height clamps 44 are secured in place by fasteners 58, such as set screws, pins, clips or other fasteners, tightened against hitch crossbar 32.

Because of the above-described aspects, cart 10 may be used simultaneously with mower 12 to improve functionality of the system. Mower 12 movement forward or backward along no straight paths will cause caster wheels 62 to independently articulate to align parallel to the direction of motion of mower 12. When mower 12 turns, using the zero-turn capabilities, casters wheels 62 and mower 12 front wheels 20 rotate independently to align perpendicular to vertical axis 18 of mower 12. The articulating of caster wheels 62 helps insures that caster wheels 62 will roll parallel to the direction of motion of mower 12 in any combination of movements mower 12 is capable of. Caster wheels 62 also retain contact with the ground independently regardless of the lateral angle by which cart 10 articulates because sleeve and pin joint 54 pivots about longitudinal axis 28 at the same time that hitch pins 50 allow cart 10 to pivot about lateral axis 30.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practices in the art to which this disclosure pertains.

1. A mower and cart system comprising
a mower having a mower frame, a seat supported by the mower frame, a plurality of wheels supporting the mower frame, and at least one blade supported by the mower frame and configured to cut grass, the plurality of wheels including first and second wheels configured to power propulsion of the mower and cooperating to define a wheel axis of rotation,
a cart having a cart frame and at least one wheel supporting the cart frame, and
a hitch coupling the cart to the mower and defining first, second, and third axes of rotation between the mower and the cart, the first axis of rotation being parallel to the wheel axis, the second axis being vertical, and a third axis being perpendicular to the first and second axes of rotation, rotation about at least one of the first and third axes of rotation being unconstrained to allow rotational movement between the mower and the cart, and rotation about the second axis of rotation being constrained to substantially block rotational movement between the mower and the cart about the second axis of rotation.

2. The mower and cart system of claim 1, wherein the mower has a mower axis of rotation relative to the ground and the mower axis of rotation extends through the mower frame.

3. The mower and cart system of claim 1, wherein the plurality of wheels further include third and fourth wheels with two degrees of rotational freedom relative to the mower frame.

4. The mower and cart system of claim 3, wherein the third and fourth wheels are positioned between the wheel of the cart and the first and second wheels.

5. The mower and cart system of claim 1, wherein rotation about the first and third axes of rotation are unconstrained.

6. The mower and cart system of claim 1, wherein mower has a first handle and a second handle, the first handle controls rotation of the first wheel and the second handle controls rotation of the second wheel.

7. The mower and cart system of claim 1, wherein the seat faces in a forward direction and the cart is positioned forward of the seat.

8. The mower and cart system of claim 1, wherein the wheel of the cart is configured to rotate about a horizontal axis of rotation relative to the cart frame and about a vertical axis of rotation relative to the cart frame.

9. A mower and cart system comprising
a mower having a mower frame, a seat supported by the mower frame, a plurality of wheels supporting the mower frame, and at least one blade supported by the mower frame and configured to cut grass, the plurality of wheels including first and second wheels configured to power propulsion of the mower,
a cart having a cart frame and at least one wheel supporting the cart frame, and
a hitch coupling the cart to the mower, the seat facing in a forward direction and the cart is positioned forward of the seat.

10. The mower and cart system of claim 9, wherein cart is fixed against rotation about a vertical axis relative to the mower.

11. The mower and cart system of claim 9, wherein cart is configured to rotate about a first horizontal axis of rotation relative to the mower.

12. The mower and cart system of claim 11, wherein the cart is configured to rotate about a second horizontal axis of rotation relative to the mower that is perpendicular to the first horizontal axis of rotation.

13. The mower and cart system of claim 9, wherein the mower has a mower axis of rotation relative to the ground and the mower axis of rotation extends through the mower frame.

14. The mower and cart system of claim 9, wherein the wheel of the cart is configured to rotate about a horizontal axis of rotation relative to the cart frame and about a vertical axis of rotation relative to the cart frame.

15. A method of moving material using a mower and cart, the method including the steps of
providing a mower and a cart coupled a front of the mower,
loading material into the cart,
propelling the mower and cart,
constraining movement of the cart relative to the mower about a vertical axis of rotation,
rotating the cart relative to the mower about a first horizontal axis of rotation, and
rotating the cart relative to the mower about a second horizontal axis of rotation that is perpendicular to the first horizontal axis of rotation.

16. The method of claim 15, wherein the mower includes a mower frame and first, second, third, and fourth wheels supporting the mower frame, further comprising the steps of
rotating the first and second wheels relative to the mower frame about a first horizontal axis of rotation,
constraining rotation of the first and second wheels relative to the mower frame about a vertical axis of rotation,
rotating the third and fourth wheels relative to the mower frame about a first horizontal axis of rotation, and
rotating the third and fourth wheels relative to the mower frame about a vertical axis of rotation.

17. The method of claim 15, further comprising the step of mowing grass with the mower.

18. The method of claim 15, further comprising the step of rotating the mower and cart about a vertical axis of rotation that extends through the mower.
